(19) United States
(12) Patent Application Publication
(10) Pub. No.: US 2023/0118325 A1
(43) Pub. Date: Apr. 20, 2023

(54) METHOD AND APPARATUS HAVING A MEMORY MANAGER FOR NEURAL NETWORKS

(71) Applicant: Roviero, Inc, San Jose, CA (US)

(72) Inventors: Deepak Mital, Livermore, CA (US); Sambhu Surya Mohan, Elamakkara (IN); Anoop Basil, Kolenchery (IN); Thomas Paul, Edathala (IN)

(21) Appl. No.: 17/968,515

(22) Filed: Oct. 18, 2022

Related U.S. Application Data
(60) Provisional application No. 63/341,766, filed on May 13, 2022.
(60) Provisional application No. 63/256,902, filed on Oct. 18, 2021.
(60) Provisional application No. 63/256,908, filed on Oct. 18, 2021.

(51) Int. Cl. G06F 9/50

(52) U.S. Cl. CPC G06F 9/5016

(57) ABSTRACT

An artificial intelligence processor can optimize the usage of its neural network to reduce the need to access external memory during operations. The artificial intelligence processor can have multiple arithmetic logic units each configured to have one or more computing engines to perform the computations for the AI system. A set of schedulers are each configured to have a local scheduler memory. A memory manager is configured to execute an instruction set from a compiler. The compiler is configured to divide the multiple arithmetic logic units into multiple clusters. The compiler is configured to assign each cluster a scheduler from the set of schedulers. The scheduler is configured to cooperate with a memory manager so that a fetch of data from an external memory to the local scheduler memory occurs a single time per calculation.

### RELATED APPLICATION

This application claims priority to and the benefit of under 35 USC 119 of U.S. provisional patent application titled “A method and apparatus having a scalable architecture for neural networks,” filed Oct. 18, 2021, Ser. No. 63/256,908, as well as priority to and the benefit of under 35 USC 119 of U.S. provisional patent application titled “A method and apparatus having a memory manager for neural networks,” filed Oct. 18, 2021, Ser. No. 63/256,902, as well as priority to and the benefit of under 35 USC 119 of U.S. provisional patent application titled “A general purpose functionality processor with a scalable architecture for neural networks” filed May 13, 2022, Ser. No. 63/341,766, which are incorporated herein by reference in their entirety.

### NOTICE OF COPYRIGHT

A portion of this disclosure contains material that is subject to copyright protection. The copyright owner has no objection to the facsimile reproduction by anyone of the material subject to copyright protection as it appears in the United States Patent & Trademark Office's patent file or records, but otherwise reserves all copyright rights whatsoever.

### FIELD

Embodiments generally relate to an apparatus and a method having a memory manager for neural networks.

### BACKGROUND

An artificial neural network mimics biological neural processes to process large sets of data. A node, or artificial neuron, receives an input signal, which the node then processes to produce an output signal to pass via an edge to one or more subsequent nodes in a chain. The neuron can apply a weight to the output signal to increase or decrease the strength of the signal based on learned behavior. The neurons can be grouped into layers based upon the type of transformation the neuron is applying. An input layer can receive a signal, pass that signal through multiple transformation layers, before producing a transformed signal at an output layer. A convolutional neural network is frequently used in the field of image processing.

### SUMMARY

Provided herein are some embodiments. In an embodiment, the design is directed to an apparatus and a method to efficiently do the computation for neural networks.

These and other features of the design provided herein can be better understood with reference to the drawings, description, and claims, all of which form the disclosure of this patent application.

An artificial intelligence processor can optimize the usage of its neural network to reduce the need to access external memory during operations. The artificial intelligence processor can have multiple arithmetic logic units each configured to have one or more computing engines to perform the computations for the AI system. A set of schedulers are each configured to have a local scheduler memory. A memory manager is configured to execute an instruction set from a compiler. The compiler is configured to divide the multiple arithmetic logic units into multiple clusters. The compiler is configured to assign each cluster a scheduler from the set of schedulers. The scheduler is configured to cooperate with a memory manager so that a fetch of data from an external memory to the local scheduler memory occurs a single time per calculation.

### BRIEF DESCRIPTION OF THE DRAWINGS

The multiple drawings refer to the example embodiments of the design.

FIG. 1 illustrates, in a block diagram, one embodiment of an AI processor that has a neural network.

FIG. 2 illustrates, in a flowchart, one embodiment of a method for managing the memory of an artificial intelligence processor.

FIG. 3 illustrates, in a flowchart, one embodiment of a method for allocating memory.

FIG. 4 illustrates, in a block diagram, one embodiment of a memory allocation.

FIG. 5 illustrates, in a flowchart, one embodiment of a method for assigning memory.

FIG. 6 illustrates, in a flowchart, one embodiment of a method for optimizing a graph representing a data set model.

FIG. 7 illustrates, in a block diagram, one embodiment of a data path.

FIG. 8 illustrates, in a block diagram, another embodiment of a data path.

FIG. 9 illustrates, in a flowchart, one embodiment of a method for sorting a graph representing a data set model.

FIGS. 10A to 10C illustrate, in a block diagram, one embodiment of a graph of nodes.

FIG. 11 illustrates, in a flowchart, one embodiment of a method for subgraphing.

FIG. 12 illustrates, in a block diagram, one embodiment of frame level clustering.

FIG. 13 illustrates, in a block diagram, one embodiment of channel level clustering.

FIG. 14 illustrates, in a block diagram, one embodiment of data level clustering.

FIG. 15 illustrates, in a flowchart, one embodiment of a method for electronic design automation.

FIG. 16 illustrates, in a block diagram, one embodiment of a computing system used with managing the memory of an artificial intelligence processor.

While the design is subject to various modifications and alternative forms, specific embodiments thereof have been shown by way of example in the drawings and will herein be described in detail. The design should be understood to not be limited to the particular forms disclosed, but on the contrary, the intention is to cover all modifications, equivalents, and alternatives falling within the spirit and scope of the design.

### DETAILED DISCUSSION

In the following description, numerous specific details are set forth, such as examples of specific data signals, named components, number of wheels in a device, etc., in order to provide a thorough understanding of the present design. It will be apparent, however, to one of ordinary skill in the art that the present design can be practiced without these specific details. In other instances, well known components or methods have not been described in detail but rather in a block diagram in order to avoid unnecessarily obscuring the present design. Further, specific numeric references such as a first computing engine, can be made. However, the specific numeric reference should not be interpreted as a literal sequential order but rather interpreted that the first computing engine is different than a second computing engine. Thus, the specific details set forth are merely exemplary. Also, the features implemented in one embodiment may be implemented in another embodiment where logically possible. The specific details can be varied from and still be contemplated to be within the spirit and scope of the present design. The term coupled is defined as meaning connected either directly to the component or indirectly to the component through another component.

The apparatus and method can efficiently do computations for neural networks as well as have a scalable architecture to adapt to most artificial intelligence (AI) networks, as well as optimize memory accesses and allocation, and some example features will be discussed below.

The apparatus and method can efficiently do computations for neural networks as well as have a scalable architecture to adapt to most AI networks, as well as optimize memory accesses and allocation, and some example features will be discussed below. The AI processor is tailored to support Artificial Intelligence including neural networks. The AI processor can be fabricated in an integrated circuit. The integrated circuit efficiently processes and executes Artificial Intelligence operations. The integrated circuit has adapted components to process and execute Artificial Intelligence operations, including computations for a neural network having weights with a sparse value. The integrated circuit contains a scheduler, one or more arithmetic logic units (ALUs), a communication bus, a mode controller or a memory manager, and one or more random access memories configured to cooperate with each other to process and execute these computations for the neural network.

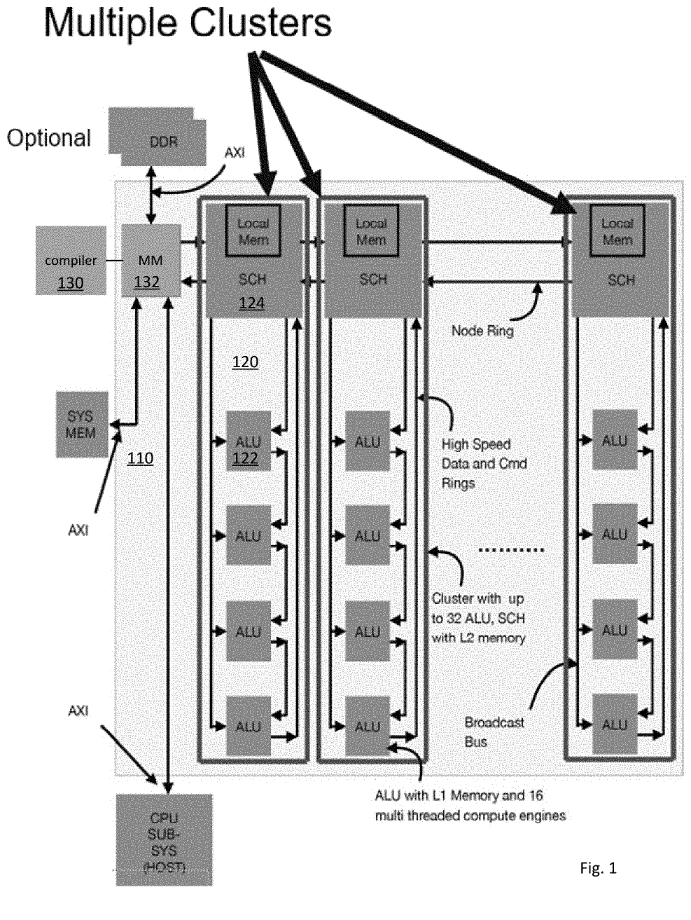

FIG. 1 illustrates, in a block diagram, one embodiment of an AI processor 110 that has a neural network. The AI processor can have one or more clusters 120 of two or more ALUs 122 managed by a scheduler 124. Each cluster has at least an ALU that has one or more compute engines (CEs) as well as a local memory. The multiple ALUs are each configured to have one or more computing engines to perform the computations for the AI system. A set of schedulers are each configured to have a local scheduler memory. Note, at least one or more of the clusters of ALUs has an output that connects to its neighboring cluster. Note, instances of the clusters are scalable using register transfer language (RTL), via parameters for performance and power including at least a number of ALUs in a cluster, a number of clusters created in an architecture of the integrated circuit, a local memory size per cluster, etc. A cluster of ALUs and local memory can further include a node ring running between the clusters and a broadcast bus. A compiler 130 can cooperate with the scheduler so that the system fetches the data via an advanced extensible interface (AXI) from the external memory to the processor chip (e.g., a double data rate (DDR) synchronous dynamic random access memory (SDRAM)) merely a single time per calculation and that dramatically reduces the amount of power consumption. The data read from the external memory/main memory DDR is sent to the local memory in the scheduler a single time. The clusters can be instantiated in parallel with each other. The local memory (embedded Flash memory and/or random access memory (RAM) can store the information associated with the AI model. Note, (as shown above) each ALU can also be instantiated with multiple CEs via a user configurable RTL setting for the integrated circuit. Each ALU contains the RAM to feed data and weights into each CE and also store the output result from the CE.

A compiler 130 for the neural network processor uses a descriptor/instruction set with specific instructions crafted to efficiently handle various operations for neural networks. For example, the compiler 130 for the neural network processor uses a descriptor/instruction set with specific instructions crafted to efficiently handle various operations, addressing modes, data types, ability to address memory locations, etc., for neural networks. These neural networks can have sparse weights, manipulate one or more dimensional data, e.g. height, width, and channels and other dimensions such as images/frames per second. In an embodiment, these neural networks can have sparse weights, manipulate three or more dimensional data including dimensions such as images/frames per second, and other issues. The descriptor/instruction set includes categories of descriptors/instructions including, for example, Control descriptors/instructions; Data descriptors/instructions (used for both input and output); Weight descriptors/instructions; and Generic descriptors/instructions including e.g., generic descriptors for data transfer, etc. Note, a set of specialized registers in the scheduler, in the node engine, etc. can be utilized to implement the descriptors/instructions for the neural network processor. Note, the user can map any AI/Compute operation onto the target hardware (HW) of this AI processor via the compiler 130. The scalable parameters for the hardware are fed into the compiler 130 at compile time. The AI processor block of IP is thus Neural Network agnostic. The compiler 130 creates instructions depending on the specifics of the neural network being implemented to dynamically form virtual connections on the hardware, configurable in many different aspects, that was instantiated. The compiler 130 can use a single instruction, multiple data (SIMD) instruction set to allow simultaneous parallel computations by each cluster, and each cluster performs the exact same instruction at any given moment just with different data.

In the neural network processor, the scheduler is responsible for sending data to each of the multiple ALUs connected to it via the broadcast bus for parallel processing. The scheduler feeds descriptors/instructions tailored to, for example, N-dimensional inputs (e.g. 3D objects) and weights for neural networks to these multiple parallel ALU compute units. The descriptors/instructions are utilized with the compiler 130 and a node direct memory access (DMA) engine that inherently handles, for example, at least three dimensional data and how to efficiently work with neural networks that have, for example, sparse weights that are either zero or are not important for the network or AI operation. The scheduler is responsible for driving and receiving data from all of the ALUs in the cluster. The scheduler can make use of signaling wires to each ALU to communicate when to start a calculation and then receive notice back when a resultant output has been produced by the ALU from the calculation.

An aspect architecturally and software-control wise is that scheduler can have multiple clusters, which are all working at that same time/working simultaneously and sharing the data, across their local memories, that comes from the external memory (e.g., DDR). The instantiated architecture and the compiler 130 cooperate to slice and dice an AI network (e.g., neural network) being implemented, into much smaller sections. The data read from the external memory (e.g., DDR) to the AI processor chip/internet protocol (IP) block is sent to the local memory (local RAM as opposed to a cache) in the scheduler a single time. Thus, the data, the model of which can be pretty large most of the time, is being fetched from the DDR into the local memory RAM merely once. This allows the DDR, which accounts for a lot of power consumption in a device, can now stay in a sleep state 90% of the time when the data merely needs to be fetched once per calculation. This component reduces the amount of data movement. Each cluster's local memory will store its portion of the entire amount of data being sent from the DDR. The local memories in each of the clusters in the scheduler generally will receive an equal portion of the entire data from the DDR to store and work within that particular local memory.

In an embodiment, the compiler 130 can have multiple sub-modules. One submodule can handle hardware instantiation to create the hardware on the chip that becomes the AI processor. A second submodule can act as a memory manager 132. A third sub module can use and supply a descriptor/instruction set used for different AI operations carried out by the hardware making up the AI processor. The memory manager is a resource optimization module. The memory manager 132 can also be a separate module from the compiler 130. The memory manager can intelligently allocate memory space based on layer type in the neural network, perform graph optimization for effective memory allocation, perform multi-clustering by tiling along the frame, channel, and data batches, perform subgraphing based on graph nodes condition, etc. The memory manager's basic responsibilities are allocation and optimization of memory, optimizing the network for hardware, converting the intermediate representation (IR) of the data structure or the code over to a compiler-specific representation, conditional subgraphing, and multi-clustering. The memory manager optimizes i) the accesses to and ii) the amount of use of memory via traversing the whole AI network (e.g., neural network) and pre-allocating that portion of the memory in the scheduler for different parts of the neural network. Each layer of the AI network requires an amount of memory calculated based on their inputs, outputs, weights, variables, and previously saved memories. These calculated memories are allocated in a logical view of the hardware memory that matches its original capacity and fixed allocations. Thus, a memory manager is configured to execute an instruction set from a compiler 130 configured to divide the multiple arithmetic logic units into multiple clusters. The memory manager is further configured to assign each cluster a scheduler from the set of schedulers. The scheduler is configured to cooperate with a memory manager so that a fetch of data from an external memory to the local scheduler memory occurs a single time per calculation.

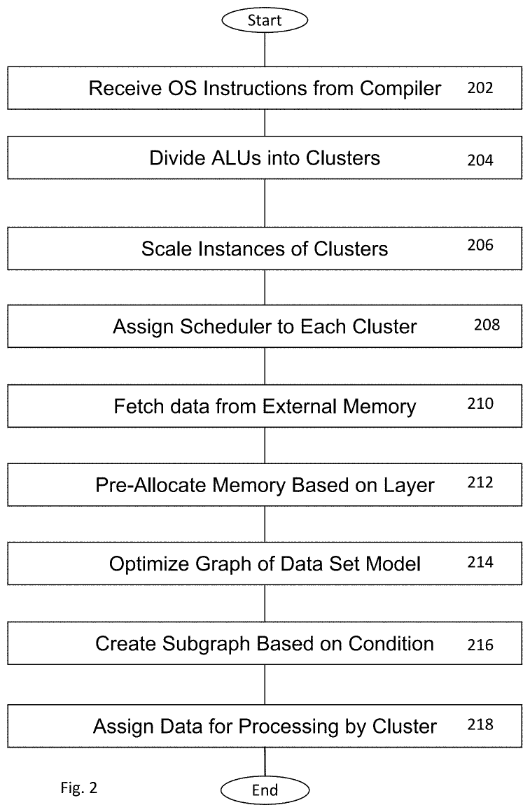

FIG. 2 illustrates, in a flowchart, one embodiment of a method for managing the memory of an AI processor. An AXI can receive in an instruction set to an AI processor to do computations for an AI system from a compiler (Block 202). The memory manager can divide multiple arithmetic logic units each having one or more computing engines into multiple clusters to perform the computations for the AI system (Block 204). The memory manager or compiler 130 can scale an amount of instances of the clusters to perform the computations for the AI system via a user configurable register transfer language parameter fed into the compiler 130 at compile time (Block 206). The memory manager can assign a scheduler with a local scheduler memory to each cluster (Block 208). The memory manager can fetch data from an external memory to the local scheduler memory in a single time per calculation (Block 210). The memory manager can pre-allocate different portions of the local scheduler memory to different parts of the neural network based on a neural network layer type (Block 212). The memory manager can optimize a graph representing the processing protocol for the data set model (Block 214). The memory manager can create a subgraph of the neural network based on a condition related to at least one of a size, a dimension, and a level number (Block 216). The memory manager can assign a portion of a data set for the AI model to the local scheduler memory for that cluster to be processed by arithmetic logic units in that cluster (Block 218).

One aspect of the memory manager is to optimize the memory accesses and an amount of memory required to implement the current neural network. The memory manager reduces the amount of memory required on chip and reduces the amount of memory accesses that are done external to the chip, such as main memory DDR. The memory manager reduces the system costs by reducing the amount of memory required to be instantiated in the chip overall and the memory manager also reduces the power consumed in network edge devices—laptops, wireless IoT devices, etc., because it doesn't access the memory as much, as well as a lower amount of memory instantiated on the AI processor chip translates to less power consumption overall by the memory. The memory manager can allow the system to implement the neural networks in software solely, or with a combination of hardware and software.

### Intelligent Memory Allocation

The memory manager can intelligently allocate memory space based on layer type in the neural network. The memory manager optimizes i) the accesses to and ii) the amount of use of the memory via traversing the whole AI network (e.g., neural network) and pre-allocating different portions of the local memory in the scheduler for different parts of the neural network. Again, each layer of the AI network requires an amount of memory calculated based on their inputs, outputs, weights, variables, and previously saved memories. These calculated memories are allocated in a logical view of the hardware memory that matches its original capacity and fixed allocations.

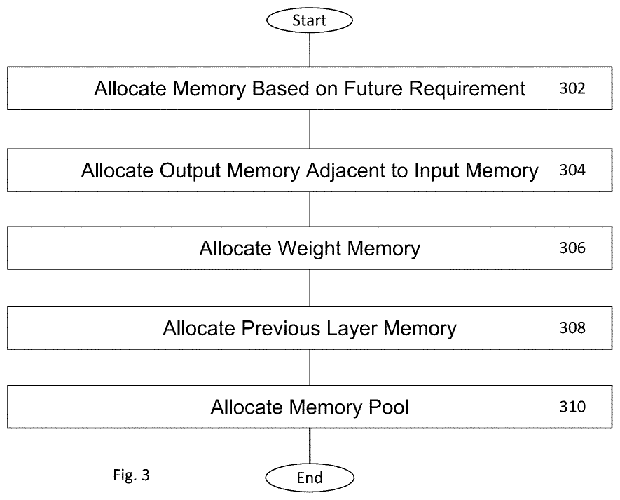

FIG. 3 illustrates, in a flowchart, one embodiment of a method for allocating memory. The memory manager can allocate a portion of the local scheduler memory based on a future memory requirement (Block 302). The memory manager can allocate output memory adjacent to the input memory in the local scheduler (Block 304). The memory manager can allocate weight memory for at least one of a convolution layer, a depthwise layer, and a dense layer in the local scheduler (Block 306). The memory manager can allocate a previous layer memory in the local scheduler to store values for a subsequent neural network layer (Block 308). The memory manager can allocate a memory pool in the local scheduler for at least one of i) outputs and ii) weights (Block 310).

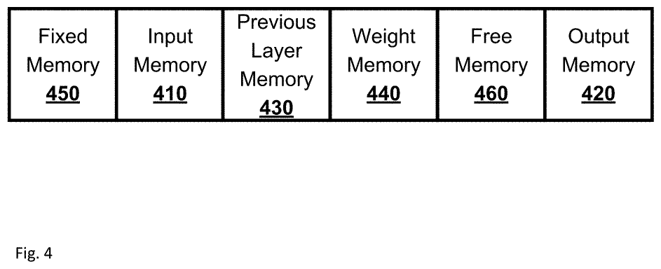

FIG. 4 illustrates, in a block diagram, one embodiment of a memory allocation. The scheduler's total amount of local memory can be allocated into many sections such as input memory 410 (e.g., 175K), output memory 420 (e.g., 30K) previous layer memory 430 (e.g., 30K), weights memory 440 (e.g., 20K), descriptor memory (e.g., 10K), a fixed memory 450, or free memory 460. In general, the memory manager allocates a memory pool for input data for the neural network for all layers, allocates a memory pool for weights, allocates a memory pool for outputs from the neural network for all layers, allocates a memory pool for storing the data for an older layer memory when it is needed by a layer further in the network, can intelligently allocate memory space based on the future memory requirements, allocates the weights memory for merely Convolution, Depthwise, and Dense, allocate some memory required for intermediates, and other allocations. These allocations can be dynamically determined and are factored in and compared to a total amount of memory capacity that the local memory has. Note, part of the instruction set for the AI processor allows the system to keep track of what is in the input memory, what was in the previous memory layer, what is in the output memory, etc. The instruction set for the AI processor allows every instruction to be able to address the memory and that assists the memory manager to do its job. In an embodiment, the memory manager can also use a portion of the main memory (e.g., DDR memory) in addition to the local memory in the scheduler, but still all in an optimized manner.

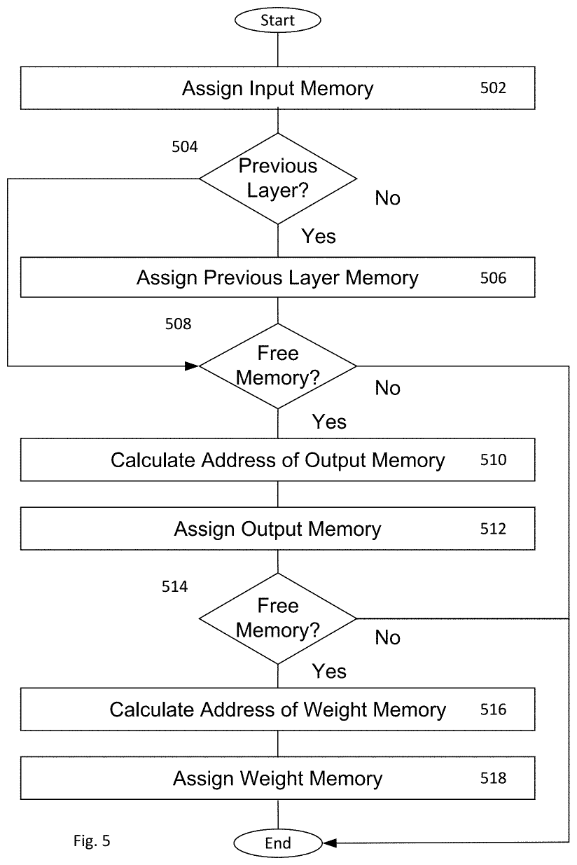

FIG. 5 illustrates, in a flowchart, one embodiment of a method for assigning memory. For example, the memory manager can assign and allocate an amount for the input memory (Block 502). Thus, the memory manager allocates an amount for the input memory and then the input address range in the local memory is specified. For each of the other memory allocations, since the input address is always the output address of the previous layer no extra calculation is done to find this address.

Next, if the previous layer has data present (Block 504), the memory manager assigns and allocates an amount of local memory for use by a later layer in the neural network. When yes, the memory manager assigns the previous layer's data in the local memory and allocates an amount for that (Block 506). The memory manager allocates the previous layer's saved output data in the specified address range of the local memory. This follows the same rule as the input memory.

Next, the memory manager will make sure that there's at least enough a minimum amount of free memory available (Block 508). When ‘yes’, the memory manager can calculate the address of the output memory (Block 510) and assign and allocate an amount of output memory needed (Block 512). Thus, the memory manager will find the address for output memory in the edge opposite to input memory, from the total memory capacity.

Next, the memory manager checks if there is enough free memory available to allocate a next amount of memory space (Block 514). When yes, then the memory manager will calculate an amount and address for the weights in the local memory (Block 516). The memory manager will then allocate that amount in the local memory for the weights (Block 518). The memory manager will find the address range in the local memory for the weights in memory from the total memory.

Note, the descriptor memory is minimal and can be assumed to be 2K max. Basically, descriptors need to be generated that point to the address for the input data, the output data, and the weights stored in the local memory. These descriptors are stored in the memory as well. The instruction set for the AI processor gives the capability for the scheduler to access any address in memory pointed to from the descriptor memory. The descriptor memory can be a fixed amount.

For example, the scheduler memory can dynamically allocate the total local memory capacity into 5 sections—input memory, output memory, previous layer memory, weights memory, descriptor memory, and the remainder remains as free memory. An operation of sending one set of input data will need one descriptor/instruction. In an example, the address range of the local memory for the input data memory is from 0-127K-1, output data memory is 128K-208K-1, weights memory is 208K-228K, descriptor memory 228K-230K-1, and free memory is the rest of it. The descriptor memory can be stored in the Fixed memory location. The descriptor memory can start at the 0th address of the local memory. However, with the pointer, the system is flexible to be located anywhere in local memory.

The system can be completely software-controlled and nothing is controlled by the CPU/in the gates per se and this gives the system the functionality and flexibility to implement any neural network and not consume a tremendous amount of memory and data fetches/power consumption. A combination of the cluster hardware discussed above and the software (e.g., instruction set and memory manager) together make this AI processor achieve a great amount of power reduction and improved performance.

In an embodiment, the memory manager can take in multiple neural networks and optimize for all of them to have multiple networks working simultaneously on the AI processor.

Next, as discussed, the memory manager is configured to travel the whole AI network, first figuring out as an algorithm what is the total memory requirement and then the complex task of allocating different types of memory allocations to each layer in the network.

### Graph Optimization

The memory manager uses graph algorithms for improving the performance of the resource allocated in hardware. The memory manager needs to dynamically determine an amount of memory space to allocate to store a previous layer's data. When a layer's output data is no longer needed by a subsequent layer in the network, then that layer's output data can be removed freeing up that memory space allocation for other uses. An output of a node in a network layer needs to be kept until all of the downstream nodes, which use that output as their input, have performed their calculations. Once a leaf node performs its calculation, then its output is now needed by downstream nodes but the root node initially supplying its output as an input to the leaf node that just completed its calculation, is no longer needed for that leaf node and its downstream leaf nodes. Once all of the leaf nodes one step away from the root node have completed their calculations, then the output data from the original root node can be deleted/retired/overwritten. Note, a leaf node can be referred to as merely a node and/or child node, and a root node can be referred to as a parent node. Accordingly, the memory manager would no longer need to allocate space in the previous layer's memory allocation to store the output data from the original root node that can have its output data retired. This process continues over and over again as the memory manager traverses the whole AI network (e.g., neural network) from the first node until the last node and pre-allocates that portion of the local memory in the scheduler for different parts of the neural network. The memory manager needs to determine both 1) release memory space for output data from a previous layer merely when it can be retired as well as ensure there is enough space in the memory allocations for each of the subsequent layers to do their calculations.

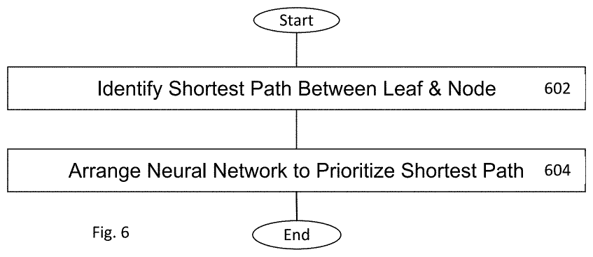

FIG. 6 illustrates, in a flowchart, one embodiment of a method for optimizing a graph representing a data set model. The memory manager can identify a shortest path between a leaf node and a root node by the number of nodes (Block 602). The memory manager can arrange the neural network to prioritize the shortest path to optimize memory reallocation (Block 604).

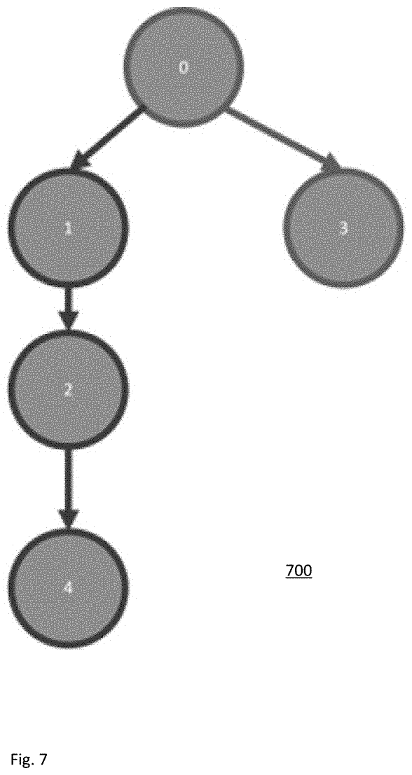

An example of a shortcut algorithm is below. FIG. 7 illustrates, in a block diagram, one embodiment of a data path 700. In this data path, using the algorithm, the path taken will be (0, 3, 1, 2, 4). This frees the output of Node 0 as soon as it finishes Node 1, hence while processing Node 4 only Node 2 memory will be stored. If the shortest path was not taken, the path will be (0, 1, 2, 4, 3), while processing Node 4 this would have node 0 and 2 memory.

### All Output Shortest Path Sorting

The memory manager uses the shortest path algorithm to optimize memory usage when branching happens in the neural network. Mostly when branching happens the output of the branched node will be input to multiple nodes lower down in the network layers. Unless all of the child nodes are processed, the output memory for that upstream node cannot be freed. The all output shortest path algorithm orders the branched path based on ascending distance to the leaf node. The path with the least distance to any leaf node gets processed first before the rest is used. This is also important in cases where the branched path is merged back in, as in the case of the shortcut node or concatenated node.

The shortest path algorithm determines the shortest path to output and helps in freeing up resources. When we reach the output, the data will be sent to the host system and the same memory space is freed in the chip. This gives a significant boost to memory allocation when the output of the network is more than 1. This is also helpful in cases where there is branching in the network and merging as in the shortcut layer. The branched out data usually has a dependency towards its input, this will be stored in the memory without freeing the memory space until all of the branches are considered, the approach chooses the shortest branches first and processes the shortest branch and at the final branch (which is the longest) the input for the branching is freed.

Networks are rearranged to traverse the shortest path to a leaf node first and after that traverse through the longer path. Final output can be rearranged in DDR memory. The memory manager can fuse a Depthwise and Conv1×1 to form Depthwise separable convolution. The memory manager can update a padding layer for just enough padding for the operation. The memory manager can remove unused extra nodes in a file. The memory manager can optionally split nodes based on channels to reduce the weight memory.

Note, there are control structures in the scheduler that allows the memory manager to do these graph optimizations.

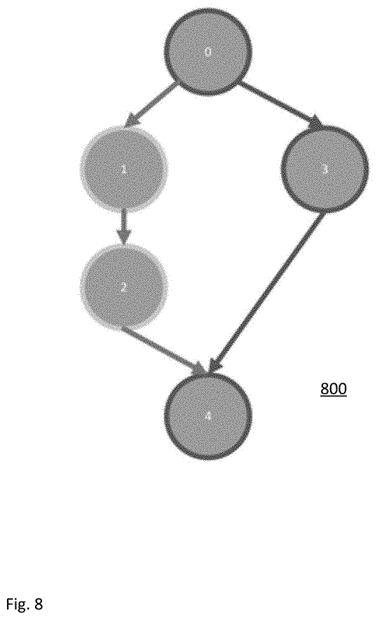

FIG. 8 illustrates, in a block diagram, another embodiment of a data path 800. In this data path, the algorithm will recommend (0, 3, 1, 2, 4). This frees the output of Node 0 as soon as it finishes Node 1, hence while processing Node 2 only Node 1 memory will be stored. If the shortest path was not taken, the path will be (0, 1, 2, 3, 4), while processing Node 2 this would have node 0 and 1 memory.

### Algorithm

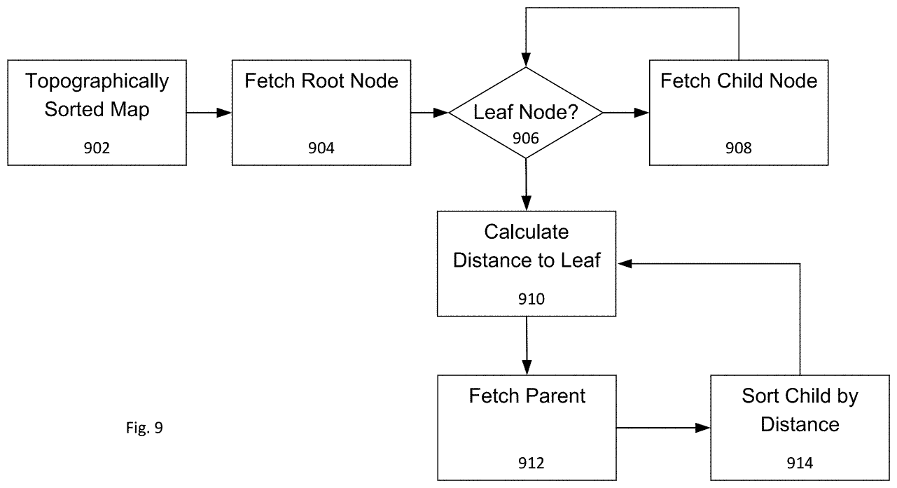

FIG. 9 illustrates, in a flowchart, one embodiment of a method for sorting a graph representing a data set model. The memory manager does a topological sort on the graph (Block 902).

The memory manager starts from the leaf node and assigns costs to each edge. The cost is calculated as the number of nodes from the current node to the leaf node. The memory manager assigns a distance of 0 for all leaf nodes. The memory manager traverses back up to the root node. At each node, the memory manager calculates the cost as the minimum distance of the child nodes plus 1.

If the node is a merge point (a node where the path merges), then assign a high penalized distance to the node. The penalized distance will be used for final sorting.

At each parent, the memory manager sorts the order of children based on their distance. This will allow the traversal to choose the child node with the minimum distance.

The memory manager fetches a root node (Block 904). If the node has a leaf (Block 906), the memory manager can fetch the child node (Block 908). The memory manager can calculate the distance to the leaf node (Block 910). The memory manager can fetch the parent node for the leaf node (Block 912). The memory manager can sort the child nodes by distance (Block 914).

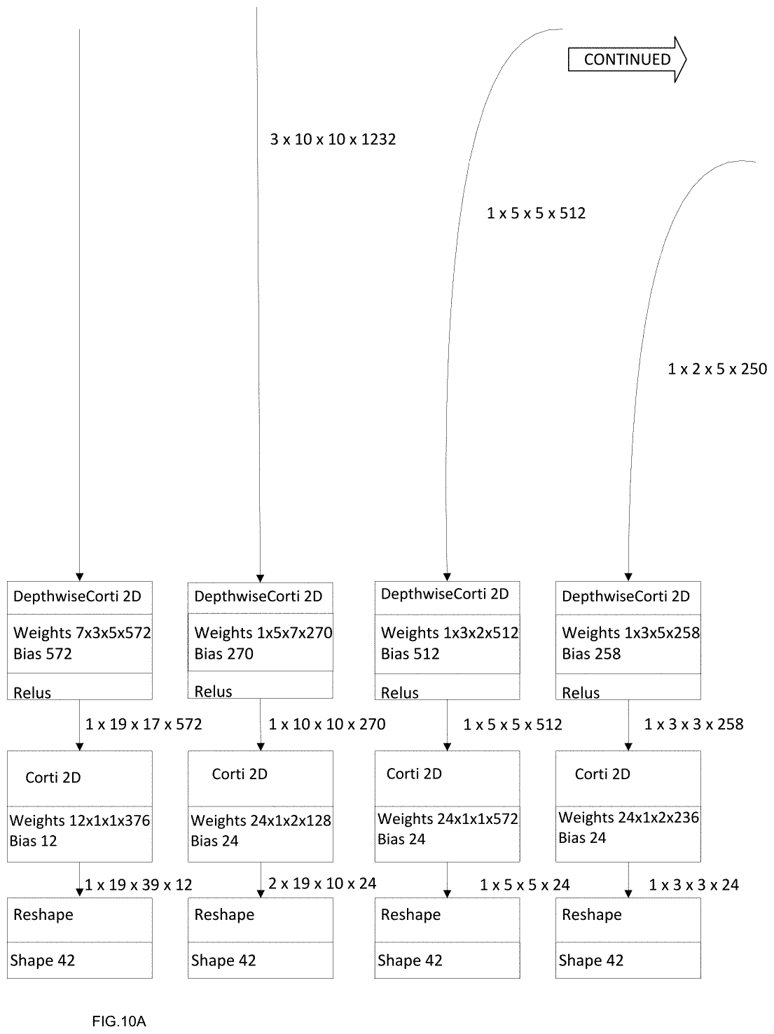

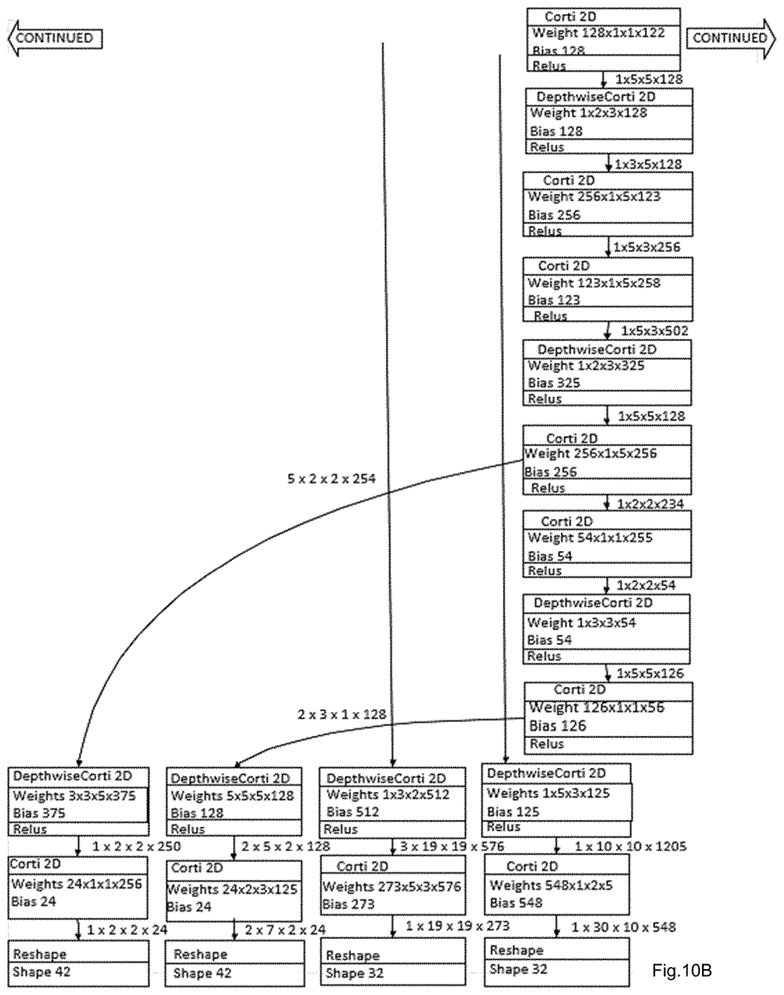

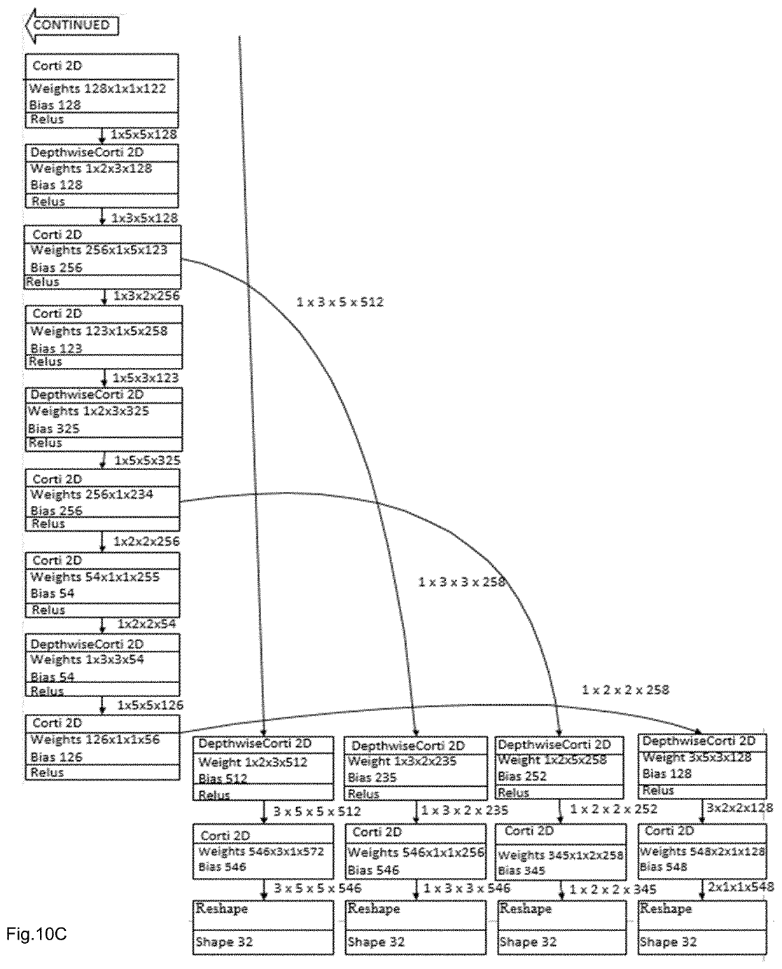

Again, neural networks can have many layers, and each layer has totally different requirements in terms of how much input memory and output memory it needs and whether it needs the data from the previous layers. FIGS. 10A to 10C illustrate, in a block diagram, one embodiment of a graph of nodes 1000 corresponding to a network of layers that gives an overview of what the memory manager has to manage, when all of these layers in the AI network, all have data that has to be stored somewhere in the local memory, but in which allocated memory spot can change, and then determine when that data can be retired when moving forward through each layer of the network in order to determine a memory allocation for the four different memory allocations for each layer of the network.

### Conditional Subgraphing

Again, the memory manager optimizes i) the accesses to the memory and ii) the amount of use of memory via traversing the whole model and its AI network (e.g., neural network) and pre-allocating different portions of the local memory in each cluster in the scheduler for different parts of the neural network. The memory manager can traverse each layer in the neural network to determine the allocations for combinations of these four types of memory (input memory, output memory, previous layer memory, and weights memory) for that layer in order to figure out how the model with its neural network can move from the first layer of the network to the last layer while still optimizing memory allocations and accesses/movement of data. The network/graph can be divided into multiple subgraphs based on conditioning. This allows the memory manager to add in more flexibility to network implementation in hardware; thereby, reducing the overhead of the hardware. For example, the memory manager using conditional subgraphing provides more flexibility for manual, as well as automated, processing of networks. The memory manager using conditional subgraphing splits the AI network being implemented into multiple subgraphs.

Each subgraph is created based on a condition, where the condition can be related to a size, a dimension, (e.g., data size, weights, and a number of images,) and/or a layer number. Thus, based on parameters/conditions, the graph is divided into subgraphs which enable the hardware to use the multiple clustering as suited for the network. This can be an automatic predefined defined condition or user defined conditions (future scope) which would enable the user for fine grained control over the operation. Each subgraph can have its own property, such as, set the weights memory constant for the whole subgraph, set the output memory constant for a subgraph, etc.

Note, each subgraph can have further subgraphs. Each subgraph has its own layer initiation and address management.

The memory manager using conditional subgraphing has support for choosing any clustering method inside a subgraph. Conditional subgraphing is enabled by the scheduler to allow the system to do that functionality.

### Conversion to a Compiler-Specific Intermediate Representation

The intermediate representation (IR) JavaScript Object Notation (JSON) is converted to compiler-specific JSON in this stage. Note, the JSON can be a lightweight data-interchange format. The compiler-specific JSON along with fields already in IR JSON will have extra fields for address as well as other functionality such as on-time padding, data-driven and weight-driven operation, and clustering.

### More on Conditional Subgraphing

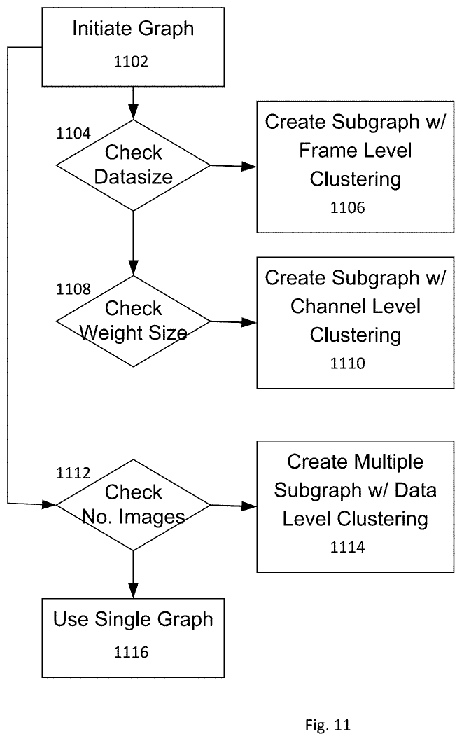

The hardware can work on multiple modes to optimize the utilization of in-built resources such as clusters, memory ALU units, and scheduler memory. This works by subdividing the network/graph into multiple subgraphs based on conditions. Again, the FIG. 11 illustrates pre-defined conditions are based on parameters such as data dimension, weight dimensions, number of images, etc. Each subgraph will initialize the data according to the mode to use.

Thus, conditional subgraphing looks at various conditions. For example, FIG. 11 illustrates, in a flowchart, one embodiment of a method for subgraphing. The memory manager can initiate a graph of the data set model (Block 1102). The memory manager will check the data size (Block 1104) and when the data size for that layer under analysis is greater than a threshold data size, then the memory manager will create a subgraph with frame level clustering (Block 1106) and for the remaining layers in the network when the data size is less than the threshold data size, then the memory manager will also check the weight size (Block 1108). When the size of the weights in that layer is greater than a threshold amount of weight size, then the memory manager will create a subgraph with channel level clustering (Block 1110). The memory manager will check on a separate condition. The memory manager will check on a fourth dimension such as the number of images (Block 1112). When the number of images in that layer is greater than the threshold amount of images, then the memory manager will create multiple subgraphs with data level clustering (Block 1114). In addition, the memory manager for layers that do not have multiple images greater than the threshold amount of images, and thus less than the threshold for images, then the memory manager uses a single graph versus multiple subgraphs (Block 1116).

Note, in the case of SSDlite, we have 2 subgraphs, one from layer 0-27 and another from layer 28-last. The subgraphing allows the SSDlite to work with multi-image scenarios differently on both subgraphs.

Multiclustering

The memory manager can perform multi-clustering by tiling along the frame, channel, and data batches. Again, the memory manager can intelligently allocate memory space based on layer type in the neural network. Some of the layers can be convolution, depthwise, activations—such as a parameter, the average pool, the maximum pool operation, the concatenation operation, the reshape operation, and many more deep learning layers. However, neural networks can have so many layers and each layer has totally different requirements in terms of how much input memory, output memory, and weights memory it needs as well as whether it needs the data from the previous layers.

Currently, the hardware supports 3 types of multiclustering, frame level, channel level, and data level. The memory manager creates the compiler JSON to enable these 3 clustering mechanisms. The module identifies the position where the network can utilize these operations and breaks the data as is required by the clustering mechanism. Another factor is that the architecture can have a scalable amount of clusters instantiated. As such, the memory manager can spread the storage requirements and workload over the amount of clusters instantiated. Each cluster has its own local memory. The memory manager examines the whole model and splits the AI network into different pieces that can be serviced by the clusters.

### Multi-Clustering—Frame Level Clustering

The memory manager can tile along the frame—height, width, and channels and then process in different clusters. Memory allocation can be done for just the tiled frame. The memory manager continues the tiling for a set of layers before merging the output. The ability of the multiple clusters to send partial or required data to each other allows other clusters to be able to complete your calculations, which enables this frame-level clustering. Note, when the size of the data is greater than the size of the weights, then slice a frame into multiple smaller portions of the data. The memory manager with the frame-level clustering looks at frames.

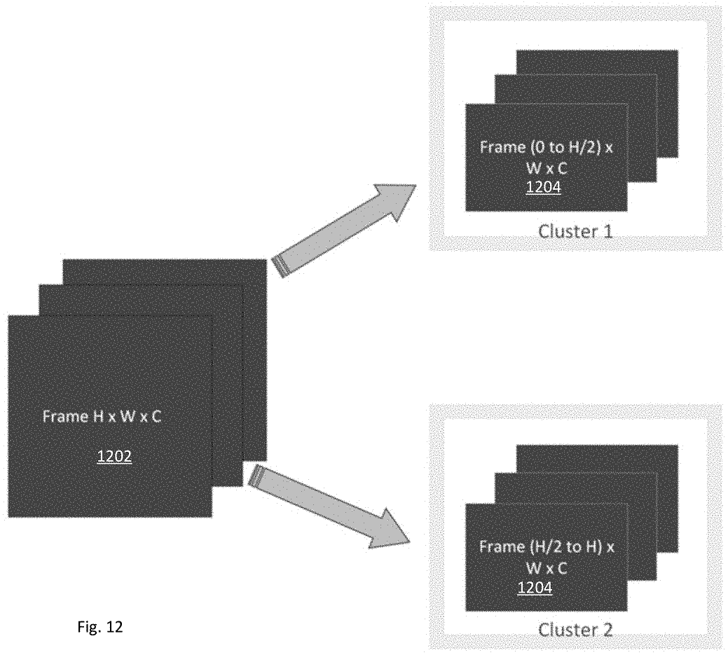

FIG. 12 illustrates, in a block diagram, one embodiment of frame-level clustering. The frame-level clustering uses part of the frame and moves forward with that till it reaches a condition where it is not viable to move forward with this approach. The clustering is done such that all of the clusters get exactly equal memory to process.

Inside the frame-level clustering, the data 1202 is divided into 2 parts 1204 initially and forwarded through the memory manager. At each layer, the memory manager checks to see whether extra rows are required at the top or bottom to complete the operation, and if needed it will transfer the required rows. For some layers such as Convolution 3×3 and Depthwise 3×3 in order to complete the full operation on the data, padding may be required.

When splitting into the different parts this requirement in the edges of the parts needs to be satisfied with overlapping rows and columns, this is made possible using the row exchange operation which will transfer the rows from the previous or next cluster to the edges of the current cluster.

### Multi-Clustering—Channel Level Clustering

The memory manager with the channel-level clustering looks at weights and channels. When the size of the data is smaller than the size of the weights, then the memory manager switches to channel level clustering. Another way of saying this is when the condition is the size of the input weight is more than the size of the data, the memory manager switches to channel level clustering.

The memory manager performs tiling along the output channels and processing in different clusters. After processing the output from each cluster, the result will be concatenated to form the original output. The memory manager performs memory allocation for the original output. The channel level clustering is enabled by the ability of the clusters to multicast all of their data. The ability to write the data to every cluster allows the scheduler to write the cluster's data to a separate location and then multicast it to other clusters.

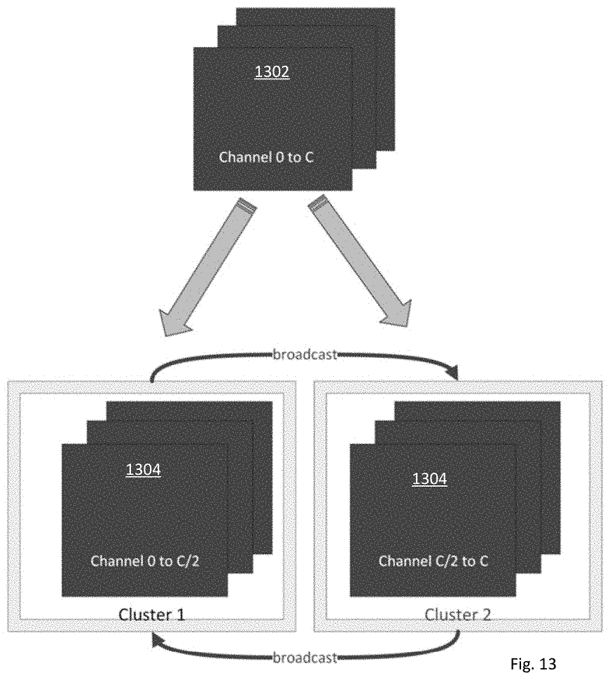

FIG. 13 illustrates, in a block diagram, one embodiment of channel level clustering. In the channel-based clustering, the data is split as tiles based on the output channels. In this approach, the original frame dimension 1302 is kept as such, and the output channels are split into batches 1304 such that each cluster takes care of an equal number of output channels. When the channels are processed, the data from each cluster is broadcasted and merged with the data of the rest of the clusters. This is then forwarded for the next layer operation. If weights are involved, then based on the output channels, it is split for each cluster.

For every cluster, the memory required will be that of the original because of the broadcasting. After broadcasting, the memory allocated should be able to accommodate the whole frame with the original number of output channels. At every step on the channel-based clustering, the whole input is used but only part of the output channels is processed in each cluster. All layers except a Reshape layer and an Average pool can be used with the channel-based clustering.

### Multi-Clustering—Data Level Clustering

The memory manager can tile along the batches of images The memory manager can perform inter-batch clustering and intra-batch clustering. Inter-batch splits the images equally to each cluster. Intra-batch splits the images for each cluster and processes all at once in a single iteration of weights. After processing the output from each cluster will be concatenated at the DDR.

Data level clustering is enabled by the ability to selectively not fetch data from the main system DDR memory. Thus, the ability for the memory manager to tell the scheduler ‘on this calculation’ don't fetch any new data because the information we need is already sitting in the local memory.

Note, data level clustering is a separate analysis and workflow than the frame level and the channel level clustering. Data level clustering tries to see if the system can reuse an amount of model data that we have fetched from the DDR memory.

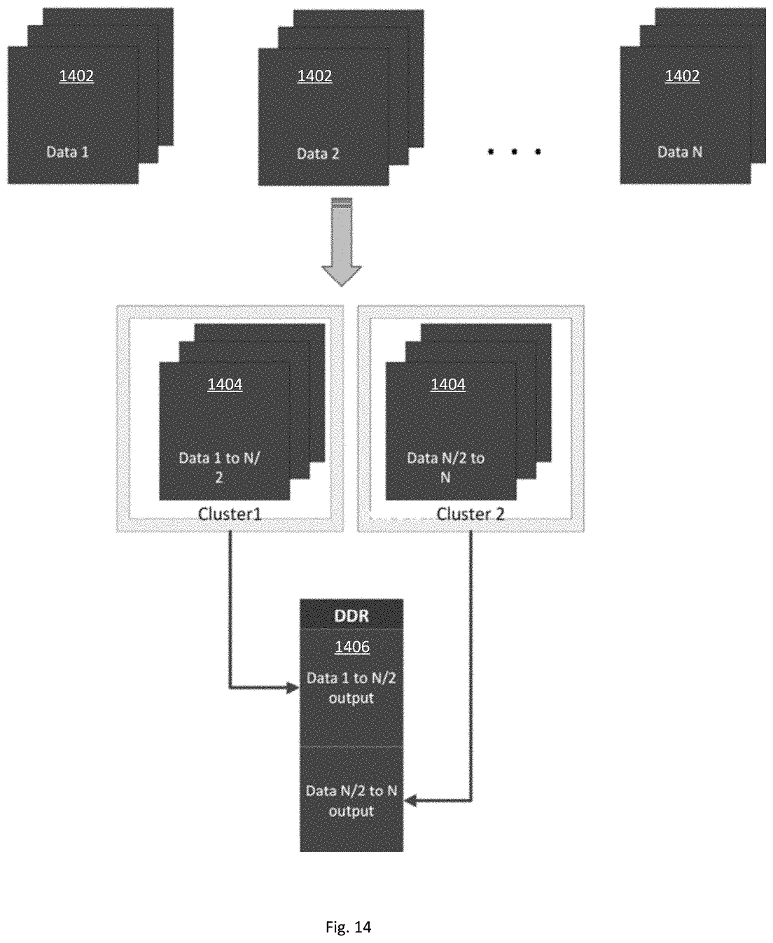

FIG. 14 illustrates, in a block diagram, one embodiment of data level clustering. A batch of input data 1402 is considered in this clustering method. In Data-based clustering, the batch is divided for each cluster 1404 and is processed as same as the working of a single cluster. If the batch of data is more than the number of clusters then it also considers the intra-batch division of data. In intra-batch division, two or more data are processed for every pass through the network. Each data is processed up to a level and the output of the operation is concatenated to form a bigger batch output 1406. This is passed through the remaining set of levels. This reduces the weight fetching frequency of each layer thereby optimizing the data transfer. Each cluster will have the intra-batch division processed at the same time; thereby, increasing the processing speed by several folds.

Next, in an embodiment, this neural network processor can be implemented as an AI processor chip such as an application specific integrated circuit (ASIC), field programmable gate array (FPGA), etc. The chip is scalable on an amount of ALUs instantiated via user configurable parameter set in the RTL. Each ALU can instantiate multiple CEs via the user configurable RTL setting for the FPGA. The depth of the Reuse RAM and Renew RAM in each ALU can also be set via the user configurable RTL setting. The size of the Reuse RAM is flexible and can be parameterized. In addition, for the clusters some configurable scalable parameters set in the RTL can include a number of ALUs in a cluster, a number of clusters created in an architecture of the integrated circuit, a local memory size per cluster, DDR or No DDR—external memory, active system memory, External shared memory, etc. These hardware configuration parameters are also input into a compiler 130 cooperating with the scheduler. This way, the compiler 130 will also know the specifics of the instantiate hardware for this implementation and then can use those specific numbers in its calculations. Thus, the compiler's architecture is flexibly designed to accept any hardware framework input and generate the corresponding processor instructions specific to the neural network and amount of clusters etc. being implemented in the scheduler. Note, the compiler 130 and the driver can enable an end-to-end integration.

In an embodiment, the neural network processing can all be implemented software.

The neural network processor can achieve >95% utilization of ALUs, as well as support all types of neural networks for AI models and types of data. The neural network processor can use a security engine to encrypt and decrypt data for security and safety.

### Electronic Design Automation

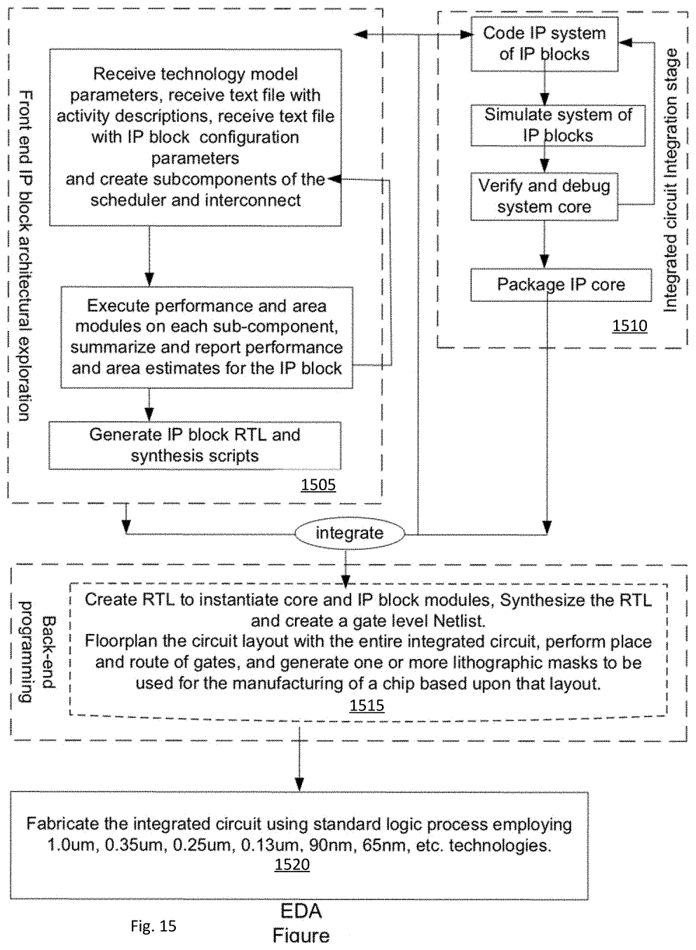

FIG. 15 illustrates a flow diagram of an embodiment of an example of a process for generating a device, such as an Intellectual Property block of functionality for an integrated circuit with the features discussed herein, in accordance with the systems and methods described herein. The example process for generating a device with designs of the integrated circuit may utilize an electronic circuit design generator, such as a Chip compiler 130, to form part of an Electronic Design Automation (EDA) tool set. Hardware logic, coded software, and a combination of both may be used to implement the following design process steps using an embodiment of the EDA tool set. The EDA tool set may be a single tool or a compilation of two or more discrete tools. The information representing the apparatuses and/or methods for the circuitry discussed herein may be contained in an Instance such as in a cell library, soft instructions in an electronic circuit design generator, or a similar machine-readable storage medium storing this information. The information representing the apparatuses and/or methods stored on the machine-readable storage medium may be used in the process of creating the apparatuses, or model representations of the apparatuses such as simulations and lithographic masks, and/or methods described herein.

Additionally, an EDA Development tool for the Intellectual Property block of functionality for an integrated circuit with the features discussed herein can produce key deliverables, for example, an IEEE-1801 UPF output file, that streamlines the integration of the IP into the customer design while ensuring both control protocol and electrical consistency and correctness throughout the implementation flow. Overall, the EDA process is going to have at least a couple steps—a first step incorporating the design of the concepts herein, a second step of simulation of the design of the concepts herein, a third step of analysis and verification, and then a fourth step of manufacturing preparation.

Aspects of the above design may be part of a software library containing a set of designs for components making up the integrated circuit and its associated parts. The library cells are developed in accordance with industry standards. The library of files containing design elements may be a stand-alone program by itself as well as part of the EDA tool set.

The EDA tool set may be used for making a highly configurable, scalable AI processor that integrally manages input and output data, control, debug and test flows, as well as other functions. In an embodiment, an example EDA tool set may comprise the following: a graphic user interface; a common set of processing elements; and a library of files containing design elements such as circuits, control logic, and cell arrays that define the EDA tool set. The EDA tool set may be one or more software programs comprised of multiple algorithms and designs for the purpose of generating a circuit design, testing the design, and/or placing the layout of the design in a space available on a target chip. The EDA tool set may include object code in a set of executable software programs. The set of application-specific algorithms and interfaces of the EDA tool set may be used by system integrated circuit (IC) integrators to rapidly create an individual IP core/block or an entire System of IP cores/blocks for a specific application. The EDA tool set provides timing diagrams, power and area aspects of each component, and simulates with models coded to represent the components in order to run actual operation and configuration simulations. The EDA tool set may generate a Netlist and a layout targeted to fit in the space available on a target chip. The EDA tool set may also store the data representing the Intellectual Property block of functionality for an integrated circuit corresponding to the features discussed herein on a machine-readable storage medium. The machine-readable medium may have data and instructions stored thereon, which, when executed by a machine, cause the machine to generate a representation of the physical components described above. This machine-readable medium stores an EDA tool set used in a chip design process, and the tools have the data and instructions to generate the representation of these components to instantiate, verify, simulate, and do other functions for this design.

Generally, the EDA tool set is used in two major stages of SOC design: front-end processing and back-end programming. The EDA tool set can include one or more of a RTL generator, logic synthesis scripts, a full verification testbench, and SystemC models.

Front-end processing includes the design and architecture stages, which includes the design of the SOC schematic. The front-end processing may include connecting models, configuration of the design, simulating, testing, and tuning of the design during the architectural exploration. The design is typically simulated and tested. Front-end processing traditionally includes simulation of the circuits within the SOC and verification that they should work correctly. The tested and verified components then may be stored as part of a stand-alone library or part of the IP blocks on a chip. The front-end views support documentation, simulation, debugging, and testing.

In block 1505, the EDA tool set may receive a user-supplied text file having data describing configuration parameters and a design for the Intellectual Property block of functionality for an integrated circuit corresponding to the features discussed herein. The data may include one or more configuration parameters for that IP block. The IP block description may be an overall functionality of that IP block such as an Interconnect, memory scheduler, etc. The configuration parameters for the interconnect IP block and/or power management components may include parameters as described previously.

The EDA tool set receives user-supplied implementation technology parameters such as the manufacturing process to implement component level fabrication of that IP block, an estimation of the size occupied by a cell in that technology, an operating voltage of the component level logic implemented in that technology, an average gate delay for standard cells in that technology, etc. The technology parameters describe an abstraction of the intended implementation technology. The user-supplied technology parameters may be a textual description or merely a value submitted in response to a known range of possibilities.

The EDA tool set may partition the IP block design by creating an abstract executable representation for each IP sub component making up the IP block design. The abstract executable representation models TAP characteristics for each IP sub component and mimics characteristics similar to those of the actual IP block design. A model may focus on one or more behavioral characteristics of that IP block. The EDA tool set executes models of parts or all of the IP block design. The EDA tool set summarizes and reports the results of the modeled behavioral characteristics of that IP block. The EDA tool set also may analyze an application's performance and allows the user to supply a new configuration of the IP block design or a functional description with new technology parameters. After the user is satisfied with the performance results of one of the iterations of the supplied configuration of the IP design parameters and the technology parameters run, the user may settle on the eventual IP core design with its associated technology parameters.

The EDA tool set integrates the results from the abstract executable representations with potentially additional information to generate the synthesis scripts for the IP block. The EDA tool set may supply the synthesis scripts to establish various performance and area goals for the IP block after the result of the overall performance and area estimates are presented to the user.

In an embodiment, a high-level synthesis of the design description (e.g., coded in C/C++) is converted into the RTL, responsible for representing circuitry via the utilization of interactions between registers.

The EDA tool set may also generate an RTL file of that IP block design for logic synthesis based on the user supplied configuration parameters and implementation technology parameters. As discussed, the RTL file may be a high-level hardware description describing electronic circuits with a collection of registers, Boolean equations, control logic such as “if-then-else” statements, and complex event sequences. The RTL design description (e.g., written in Verilog or VHDL) can be translated into a discrete netlist and/or a representation of logic gates.

In block 1510, a separate design path in a chip design is called the integration stage. The integration of the system of IP blocks may occur in parallel with the generation of the RTL file of the IP block and synthesis scripts for that IP block.

The EDA tool set may provide designs of circuits and logic gates to simulate and verify the operation of the design works correctly. The system designer codes the system of IP blocks to work together. The EDA tool set generates simulations of representations of the circuits described above that can be functionally tested, timing tested, debugged and validated. The EDA tool set simulates the system of IP block's behavior. For example, an electronic circuit simulation can use mathematical models to replicate the behavior of an actual electronic device or circuit. The simulation software allows for the modeling of circuit operation. The system designer verifies and debugs the system of IP blocks' behavior. The EDA tool set tool packages the IP core. A machine-readable storage medium may also store instructions for a test generation program to generate instructions for an external tester and the Intellectual Property block of functionality for an integrated circuit corresponding to the features discussed herein to run the test sequences for the tests described herein. One of ordinary skill in the art of electronic design automation knows that a design engineer creates and uses different representations, such as software coded models, to help generate tangible useful information and/or results. Many of these representations can be high-level (abstracted and with less details) or top-down views and can be used to help optimize an electronic design starting from the system level. In addition, a design process usually can be divided into phases and at the end of each phase, a tailor-made representation to the phase is usually generated as output and used as input by the next phase. Skilled engineers can make use of these representations and apply heuristic algorithms to improve the quality of the final results coming out of the final phase. These representations allow the electric design automation world to design circuits, test and verify circuits, derive lithographic mask(s) from Netlists of circuit and other similar useful results.

In block 1515, next, system integration may occur in the integrated circuit design process. Back-end programming generally includes programming of the physical layout of the SOC such as placing and routing, or floor planning, of the circuit elements on the chip layout, as well as the routing of all metal lines between components. The back-end files, such as a layout, physical Library Exchange Format (LEF), etc. are generated for layout and fabrication.

The generated device layout may be integrated with the rest of the layout for the chip. A logic synthesis tool receives synthesis scripts for the IP core and the RTL design file of the IP cores. The logic synthesis tool also receives characteristics of logic gates used in the design from a cell library. RTL code may be generated to instantiate the SOC containing the system of IP blocks. The system of IP blocks with the fixed RTL and synthesis scripts may be simulated and verified. Synthesizing of the design with RTL may occur. The logic synthesis tool synthesizes the RTL design to create a gate level Netlist circuit design (i.e., a description of the individual transistors and logic gates making up all of the IP sub component blocks). The design may be outputted into a Netlist of one or more hardware design languages (HDL) such as Verilog, VHDL (Very-High-Speed Integrated Circuit Hardware Description Language) or SPICE (Simulation Program for Integrated Circuit Emphasis). A Netlist can also describe the connectivity of an electronic design such as the components included in the design, the attributes of each component and the interconnectivity amongst the components. The EDA tool set facilitates floor planning of components including adding of constraints for component placement in the space available on the chip such as XY coordinates on the chip, and routes metal connections for those components. The EDA tool set provides the information for lithographic masks to be generated from this representation of the IP core to transfer the circuit design onto a chip during manufacture, or other similar useful derivations of the circuits described above. Accordingly, back-end programming may further include the physical verification of the layout to verify that it is physically manufacturable and the resulting SOC will not have any function-preventing physical defects.

In block 1520, a fabrication facility may fabricate one or more chips with the signal generation circuit utilizing the lithographic masks generated from the EDA tool set's circuit design and layout. Mask data preparation or MDP can occur for the eventual generation of actual lithography photomasks, utilized to physically manufacture the chip. Fabrication facilities may use a standard CMOS logic process having minimum line widths such as 1.0 um, 0.50 um, 0.35 um, 0.25 um, 0.18 um, 0.13 um, 0.10 um, 90 nm, 65 nm or less, to fabricate the chips. The size of the CMOS logic process employed typically defines the smallest minimum lithographic dimension that can be fabricated on the chip using the lithographic masks, which in turn, determines minimum component size. According to one embodiment, light including X-rays and extreme ultraviolet radiation may pass through these lithographic masks onto the chip to transfer the circuit design and layout for the test circuit onto the chip itself.

The EDA tool set may have configuration dialog plug-ins for the graphical user interface. The EDA tool set may have an RTL generator plug-in for the SocComp. The EDA tool set may have a SystemC generator plug-in for the SocComp. The EDA tool set may perform unit-level verification on components that can be included in RTL simulation. The EDA tool set may have a test validation testbench generator. The EDA tool set may have a dis-assembler for virtual and hardware debug port trace files. The EDA tool set may be compliant with open core protocol standards. The EDA tool set may have Transactor models, Bundle protocol checkers, OCP to display socket activity, OCPPerf2 to analyze the performance of a bundle, as well as other similar programs.

As discussed, an EDA tool set may be implemented in software as a set of data and instructions, such as an instance in a software library callable to other programs or an EDA tool set consisting of an executable program with the software cell library in one program, stored on a machine-readable medium. A machine-readable storage medium may include any mechanism that stores information in a form readable by a machine (e.g., a computer). For example, a machine-readable medium may include, but is not limited to: read only memory (ROM); random access memory (RAM); magnetic disk storage media; optical storage media; flash memory devices; DVD's; EPROMs; EEPROMs; FLASH, magnetic or optical cards; or any other type of media suitable for storing electronic instructions. However, a machine-readable storage medium does not include transitory signals. The instructions and operations also may be practiced in distributed computing environments where the machine-readable media is stored on and/or executed by more than one computer system. In addition, the information transferred between computer systems may either be pulled or pushed across the communication media connecting the computer systems.

### Computing Systems

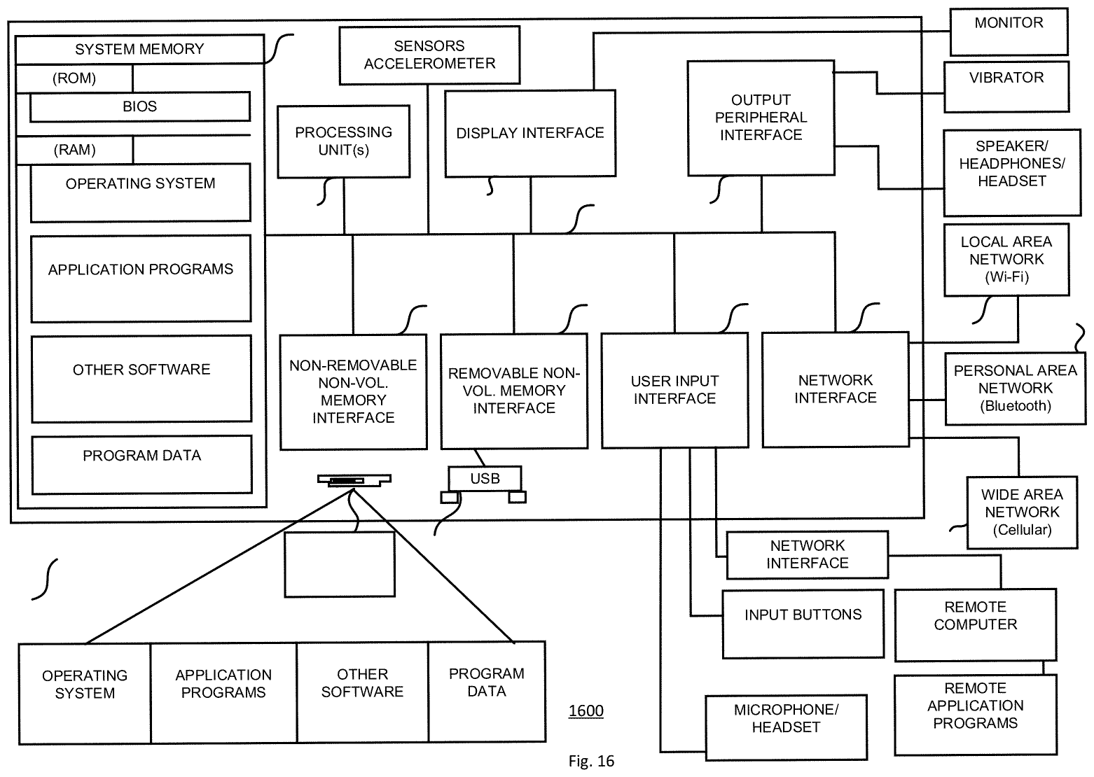

FIG. 16 illustrates, in a block diagram, one example of a computing system 1600. A computing system can be, wholly or partially, part of one or more of the server or client computing devices in accordance with some embodiments. The computing systems are specifically configured and adapted to carry out the processes discussed herein. Components of the computing system can include, but are not limited to, a processing unit having one or more processing cores, a system memory, and a system bus that couples various system components including the system memory to the processing unit. The system bus may be any of several types of bus structures selected from a memory bus or memory controller, a peripheral bus, and a local bus using any of a variety of bus architectures.

The computing system typically includes a variety of computing machine-readable media. Computing machine-readable media can be any available media that can be accessed by computing system and includes both volatile and nonvolatile media, and removable and non-removable media. By way of example, and not limitation, computing machine-readable media use includes storage of information, such as computer-readable instructions, data structures, other executable software or other data. Computer-storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible medium which can be used to store the desired information and which can be accessed by the computing device 900. Transitory media such as wireless channels are not included in the machine-readable media. Communication media typically embody computer readable instructions, data structures, other executable software, or other transport mechanism and includes any information delivery media.

The system memory includes computer storage media in the form of volatile and/or nonvolatile memory such as read only memory (ROM) and random access memory (RAM). A basic input/output system (BIOS) containing the basic routines that help to transfer information between elements within the computing system, such as during start-up, is typically stored in ROM. RAM typically contains data and/or software that are immediately accessible to and/or presently being operated on by the processing unit. By way of example, and not limitation, the RAM can include a portion of the operating system, application programs, other executable software, and program data.

The drives and their associated computer storage media discussed above, provide storage of computer readable instructions, data structures, other executable software and other data for the computing system.

A user may enter commands and information into the computing system through input devices such as a keyboard, touchscreen, or software or hardware input buttons, a microphone, a pointing device and/or scrolling input component, such as a mouse, trackball or touch pad. The microphone can cooperate with speech recognition software. These and other input devices are often connected to the processing unit through a user input interface that is coupled to the system bus, but can be connected by other interface and bus structures, such as a parallel port, game port, or a universal serial bus (USB). A display monitor or other type of display screen device is also connected to the system bus via an interface, such as a display interface. In addition to the monitor, computing devices may also include other peripheral output devices such as speakers, a vibrator, lights, and other output devices, which may be connected through an output peripheral interface.

The computing system can operate in a networked environment using logical connections to one or more remote computers/client devices, such as a remote computing system. The logical connections can include a personal area network (“PAN”) (e.g., Bluetooth®), a local area network (“LAN”) (e.g., Wi-Fi), and a wide area network (“WAN”) (e.g., cellular network), but may also include other networks. Such networking environments are commonplace in offices, enterprise-wide computer networks, intranets and the Internet. A browser application may be resident on the computing device and stored in the memory.

It should be noted that the present design can be carried out on a computing system. However, the present design can be carried out on a server, a computing device devoted to message handling, or on a distributed system in which different portions of the present design are carried out on different parts of the distributed computing system.

Another device that may be coupled to bus is a power supply such as a DC power supply (e.g., battery) or an AC adapter circuit. As discussed above, the DC power supply may be a battery, a fuel cell, or similar DC power source that needs to be recharged on a periodic basis. A wireless communication module can employ a Wireless Application Protocol to establish a wireless communication channel. The wireless communication module can implement a wireless networking standard.

In some embodiments, software used to facilitate algorithms discussed herein can be embodied onto a non-transitory machine-readable medium. A machine-readable medium includes any mechanism that stores information in a form readable by a machine (e.g., a computer). For example, a non-transitory machine-readable medium can include read only memory (ROM); random access memory (RAM); magnetic disk storage media; optical storage media; flash memory devices; Digital Versatile Disc (DVD's), EPROMs, EEPROMs, FLASH memory, magnetic or optical cards, or any type of media suitable for storing electronic instructions.

Note, an application described herein includes but is not limited to software applications, mobile apps, and programs that are part of an operating system application. Some portions of this description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms can be written in a number of different software programming languages such as C, C++, or other similar languages. Also, an algorithm can be implemented with lines of code in software, configured logic gates in software, or a combination of both. In an embodiment, the logic consists of electronic circuits that follow the rules of Boolean Logic, software that contain patterns of instructions, or any combination of both. A module can be implemented in electronic hardware, software instruction cooperating with one or more memories for storage and one of more processors for execution, and a combination of electronic hardware circuitry cooperating with software.

It should be borne in mind, however, that all of these and similar terms are to be associated with the appropriate physical quantities and are merely convenient labels applied to these quantities. Unless specifically stated otherwise as apparent from the above discussions, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers, or other such information storage, transmission or display devices.

Many functions performed by electronic hardware components can be duplicated by software emulation. Thus, a software program written to accomplish those same functions can emulate the functionality of the hardware components in input-output circuitry.

While the foregoing design and embodiments thereof have been provided in considerable detail, it is not the intention of the applicant(s) for the design and embodiments provided herein to be limiting. Additional adaptations and/or modifications are possible, and, in broader aspects, these adaptations and/or modifications are also encompassed. Accordingly, departures may be made from the foregoing design and embodiments without departing from the scope afforded by the following claims, which scope is only limited by the claims when appropriately construed.

What is claimed is:

1. A method for managing memory in a processor for an artificial intelligence (AI) system, comprising:
providing an instruction set to an AI processor to do computations for an AI system from a compiler;
dividing multiple arithmetic logic units each having one or more computing engines into multiple clusters to perform the computations for the AI system;
assigning a scheduler with a local scheduler memory to each cluster; and
fetching data from an external memory to the local scheduler memory in a single time per calculation.

2. The method for managing memory in the processor for the AI system of claim 1, further comprising:
pre-allocating different portions of the local scheduler memory to different parts of the neural network based on a neural network layer type.

3. The method for managing memory in the processor for the AI system of claim 1, wherein the AI system is an AI model, further comprising:
assigning a portion of a data set for the AI model to the local scheduler memory for that cluster to be processed by arithmetic logic units in that cluster.

4. The method for managing memory in the processor for the AI system of claim 1, further comprising:
scaling an amount of instances of the clusters to perform the computations for the AI system via a user configurable register transfer language parameter fed into the compiler at compile time.

5. The method for managing memory in the processor for the AI system of claim 1, further comprising:
allocating a portion of the local scheduler memory based on a future memory requirement.

6. The method for managing memory in the processor for the AI system of claim 1, further comprising:
allocating in the local scheduler at least one of i) output memory adjacent to the input memory in the local scheduler ii) weight memory for at least one of a convolution layer, a depthwise layer, and a dense layer in the local scheduler and iii) a previous layer memory in the local scheduler to store values for a subsequent neural network layer.

7. The method for managing memory in the processor for the AI system of claim 1, further comprising:
allocating a memory pool in the local scheduler for at least one of i) outputs and ii) weights.

8. The method for managing memory in the processor for the AI system of claim 1, further comprising:
identifying a shortest path between a leaf node and a root node by number of nodes; and
arranging the neural network to prioritize the shortest path to optimize memory reallocation.

9. The method for managing memory in the processor for the AI system of claim 1, further comprising:
creating a subgraph of the neural network based on a condition related to at least one of a size, a dimension, and a level number.

10. A non-transitory computer readable medium comprising computer readable code operable, when executed by one or more processing apparatuses in an AI memory manager to instruct a computing device to perform the method of claim 1.

11. An artificial intelligence (AI) processor to do computations for an AI system, comprising:
multiple arithmetic logic units each configured to have one or more computing engines to perform the computations for the AI system;
a set of schedulers each configured to have a local scheduler memory;
a memory manager configured to execute an instruction set from a compiler configured to divide the multiple arithmetic logic units into multiple clusters and to assign each cluster a scheduler from the set of schedulers, the scheduler configured to cooperate with a memory manager so that a fetch of data from an external memory to the local scheduler memory occurs a single time per calculation.

12. The AI processor of claim 11, wherein the memory manager is further configured to pre-allocate different portions of the local scheduler memory to different parts of the neural network based on a neural network layer type, and assign a portion of the data set model to the local scheduler memory for processing by the cluster.

13. The AI processor of claim 11, wherein the memory manager is further configured to assign a portion of the data set model to the local scheduler memory for processing by the cluster.

14. The AI processor of claim 11, wherein the compiler is configured determine a scalable amount of instances of the clusters to perform the computations for the AI system via a user configurable register transfer language parameter fed into the compiler at compile time.

15. The AI processor of claim 11, wherein the memory manager is further configured to assigns a portion of the local scheduler memory based on a future memory requirement, and the AI processor is configured to do computations for the AI system as well as other AI operations.

16. The AI processor of claim 11, wherein the memory manager is further configured to identify a shortest path between a leaf node and a root node by a number of nodes and arrange the neural network to prioritize the shortest path to optimize memory reallocation.

17. The AI processor of claim 11, wherein the memory manager is further configured to create a subgraph of the neural network based on a condition related to at least one of a size, a dimension, and a level number.

18. The AI processor of claim 11, wherein the memory manager is further configured to create a subgraph with frame-level clustering when data size is greater than weight size.

19. The AI processor of claim 11, wherein the memory manager is further configured to create a subgraph with channel-level clustering when an input weight size is more than data size.

20. The AI processor of claim 11, wherein the memory manager is further configured to create multiple subgraphs with data level clustering when the number of images exceeds a maximum image threshold.
